(19) United States
(12) Patent Application Publication
(10) Pub. No.: US 2012/0311796 A1
(43) Pub. Date: Dec. 13, 2012

(54) APPARATUS AND METHOD FOR PRODUCTION OF NATURAL DYE

(76) Inventors: Mimi Sakinah ABDUL MUNAIM, Pahang Darul Makmur (MY); Zularisam Ab Wahid, Pahang Darul Makmur (MY)

(21) Appl. No.: 13/590,734

(22) Filed: Aug. 21, 2012

Related U.S. Application Data
(62) Division of application No. 12/765,078, filed on Apr. 22, 2010.

(30) Foreign Application Priority Data
Oct. 14, 2009 (MY) PI 20094319

(51) Int. Cl. C09B 61/00

(52) U.S. Cl. 8/438

(57) ABSTRACT

The invention relates to an apparatus and method for production of natural dye from skin of fruits using submerged membrane water extractor system. The process uses an ultrafiltration submerged membrane and nanofiltration cross flow membrane. The product containing the natural dye flows through the membrane contains plentiful of pure natural dye. This process is the integrated by extractor and membrane (ultrafiltration and nanofiltration) technology.

### CROSS REFERENCE TO RELATED APPLICATION

This application is a Divisional of co-pending U.S. application Ser. No. 12/765,078, filed Apr. 22, 2010, for which priority is claimed under 35 U.S.C. §120; and this application claims priority of Application No. PI 20094319 filed in Malaysia on Oct. 14, 2009 under 35 U.S.C. §119, the entire contents of all of which are hereby incorporated by reference.

### FIELD OF INVENTION

This invention relates to an apparatus and method for production of natural dye from skin of fruits using a submerged membrane water extraction system.

### BACKGROUND OF INVENTION

Today dyeing is a complex, specialized science. Nearly all dyestuff are currently produced from synthetic compounds. This means that costs have been greatly reduced and certain applications far enhanced. Natural dyes can offer not only a rich and varied source of dyestuff, but also the possibility of an income through sustainable harvest of the dye plants. Also, they have a far superior aesthetic quality, which is more pleasing to the eye. Scientific research has evidenced a wealth of extraordinary properties on behalf of dyestuff producing plants, making them available for use in new and differentiated production fields, which can provide farmers with a valuable economic resource.

The separation membrane employing method can realize high reliability since it is suitable for stably providing a desired water quality based on a size of pore formed in the separation membrane. Furthermore, it is unnecessary for the separation membrane employing method to perform a heating process. In this respect, the separation membrane employing method is advantageous in that it can be widely utilized in various separations using microbe that may be affected by the heating process. The separation membrane may include a flat-type membrane having a flat cross section, and a hollow fibre membrane having a hollow therein. In case of the hollow fibre membrane, there are micro-pores provided on a surface of tubular fiber structure including inner and outer diameters therein, so that pollutants are filtered through the micro-pores included in the hollow fiber membrane. In comparison to the flat-type membrane, the hollow fibre membrane has the larger surface area owing to its inner and outer diameters. The submerged-type hollow fibre membrane module is formed by steps of forming a bundle of hollow fiber membranes collected, and fixing the bundle of hollow fiber membranes in a module case, wherein these steps are referred to as a potting process.

### SUMMARY OF THE INVENTION

Accordingly, there is provided an apparatus, the apparatus includes at least an extractor means, at least a compressed air means, at least a hollow ultrafiltration membrane means, at least a product tank means and at least a hollow fiber nanofiltration cross flow membrane means.

Further, the present invention relates to a method for production of natural dye from skin of fruits comprising the steps of extraction, membrane fouling control, separation and purification.

The present invention consists of several novel features and a combination of parts hereinafter fully described and illustrated in the accompanying description and drawings, it being understood that various changes in the details may be made without departing from the scope of the invention or sacrificing any of the advantages of the present invention.

### BRIEF DESCRIPTION OF THE DRAWINGS

The present invention will be fully understood from the detailed description given herein below and the accompanying drawing which is given by way of illustration only, and thus is not limitative of the present invention, wherein:

FIG. 1 shows a schematic diagram of the submerged membrane water extractor for the production of natural dye.

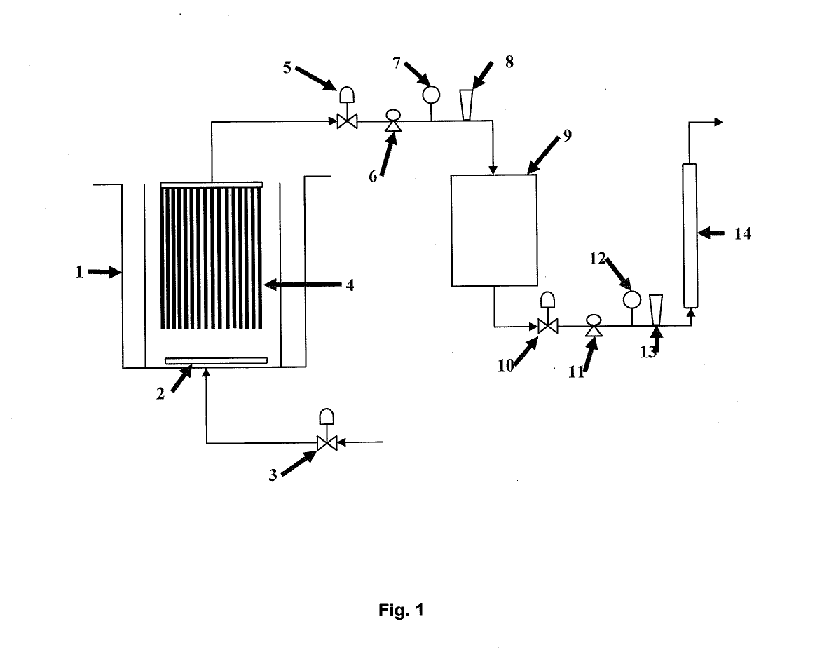

### DETAILED DESCRIPTION OF PREFERRED EMBODIMENTS

The membrane system is developed using the hollow fiber ultrafiltration membranes. The membrane is assembled in a modular form with appropriate membrane surface area. Before designing the submerged membrane water extractor system, identification of the feed solution characteristics is crucial in order to best design the right membrane for the separation and purification processes. Pretreatment consideration is very important to the present system in order to enhance membrane separation and purification performance, also to prolong the membrane lifetime. The ability to manufacture hollow fiber membrane and design proper pretreatment unit will enhance the ability of this membrane system to be used in a wide variety of feed quality and operational conditions. In the natural dye production process, fruit skin and water are fed concurrently into the extractor (1). This is to maintain the volume inside the reactor. In addition to that, the temperature and pH of the extractor are controlled at 40 to 70±0.5° C. and 6.5 to 7.5 respectively by water bath and pH controller. The compressed air (2) is supplied into the extractor (1) for the mixing and as membrane fouling controller purposes, controlled by safety valve (3).

After 1 to 3 hours aqueous solution of natural dye from fruit skin is extracted, the product (natural dye) is continuously channeled to an ultrafiltration submerged membrane (4) with molecular weight cut-off (MWCO) of 0.5 to 0.8 μm for separation process. This will affect the passage of substantial portion of natural dye through the membrane (4), while retaining substantially all of the other fruit skin. The hollow fiber ultrafiltration submerged membranes modules (4) are vertically assembled inside the extractor (1). The valve (5), pump (6), pressure gauge (7) and flowmeter (8) are assembled in order to control the flowrate of the natural dye and impurities to the product tank (9).

The permeate stream which is rich in natural dye then channeled through the nanofiltration cross flow membrane (14) with MWCO of 0.005 to 0.01 μm for purification process in order to obtain pure natural dye. The valve (10), pump (11), pressure gauge (12), flowmeter (13) and hollow fiber nanofiltration cross flow membrane module (14) are assembled beside the submerged membrane water extractor (1). The permeate stream which contains plentiful of pure natural dye is latter drained as a product, whilst the impurities and small amount of natural dye are retained in product tank (9). The novel hybrid system consists combination of two types of membranes; ultrafiltration (4) and nanofiltration cross flow membranes (14). This sophisticated design is fabricated to overcome flux declination during separation and purification processes, as well as an appropriate system for natural dye production from fruit skin.

The methods of this invention offer substantial advantages over previously available methods which use fruit skin of Hylocereus Polyrhyzus Costaricansis, Garcinia mangostana and Melastoma malabathricum which tend to produce low cost of natural dye production. The method is also applicable for other types of plants and fruits commonly used for the production of natural dye.

Additionally, the invention has applicability to produce, separate and purify natural dye simultaneously and continuously without any downtime for membrane cleaning procedure, reactants recovery and purification process.

1. A method for production of natural dye from skin of fruits comprising the steps of:
a) extracting aqueous solution of natural dye from skin of fruits;
b) controlling membrane fouling by a compressed air means (2);
c) separating the aqueous solution of the natural dye through hollow fiber ultrafiltration submerged membrane (4) to obtain the permeate stream;
d) storing the permeate stream of natural dye a product tank (9);
e) purifying the permeate stream of the natural dye by channeling the permeate stream into a hollow fiber nanofilteration cross flow membrane (14) to obtain pure natural dye.

2. The method as claimed in claim 1, wherein the skin of fruits contained in an extractor (1) are mixed with water in controlled temperature and pH.

3. The method as claimed in claim 1, wherein the temperature of the extractor (1) is controlled between 40 to 70±0.5 ° C. by water bath.

4. The method as claimed in claim 1, wherein the pH of the extractor (1) is controlled between 6.5 to 7.5 by pH controller.
